(19) United States
(12) Patent Application Publication
(10) Pub. No.: US 2012/0164610 A1
(43) Pub. Date: Jun. 28, 2012

(54) CHILDREN'S FLASHCARDS SYSTEM eBOOK CLIPBOARD TAB

(76) Inventor: Steven Patrick Pascale, San Clemente, CA (US)

(21) Appl. No.: 13/334,478

(22) Filed: Dec. 22, 2011

Related U.S. Application Data
(60) Provisional application No. 61/460,166, filed on Dec. 27, 2010.

(51) Int. Cl. G09B 1/00; B43L 1/00

(52) U.S. Cl. 434/159; 434/408

(57) ABSTRACT

The present invention relates to a system and method of utilizing flashcards-like clipboards, wet erase pen, die cut alphabet letters and numbers, and magnetic receiver plates having female die cut holes for the die cut letters and numbers, etc. for children to learn while playing games. The clipboard of the present invention is generally rectangular with concave sides and rounded corners. It has many unique features including a wet-erase surface for writing and learning, an integral clip for clipping additional notes, an ID holder for holding identification card. It can also be used for tabbing projection above a sheet of paper and as an aid to help electronic book reading for children and adults with reading challenges. The clipboard is also designed to be accompanied by additional clipboards held together by a book ring that can be worn with a lanyard or put in a pocket as flashcards.

### REFERENCE TO RELATED APPLICATIONS

This patent application claims the benefit of U.S. Provisional Application No. 61/460,166 filed on Dec. 27, 2010, the disclosure of which is incorporated herein by reference in its entirety.

### BACKGROUND OF THE INVENTION

1. Field of the Invention

The present invention relates to office supplies, and more particularly to devices for children's educational products and organizing pertinent information.

2. Description of Related Art

According to Kathy Hirsh-Pasek, PH.D., Roberta Golinkoff, PH.D., and Diane Eyer, PH.D., parents have become stressed out with drilling academics to their children. After decades of research, scientist and child development experts have come to a conclusion: Play is the best way for children to learn. The accelerated-learning industry has gotten off track. The overwhelming scientific evidence shows the following: (A) Children who are prematurely pushed into regimented academic instruction display less creativity and enthusiasm for learning in later years (B) Children who memorize isolated facts early in life show no better long-term retention than their peers (C) Children who learn through play also develop social and emotional skills, which are critical for long-term success. It has once been said that a child's work is “Play” and that a nurturing home life full of imagination play and love of learning prevails over the cult of achievement. Essentially, play is the best way for children to learn.

The use of flashcards as an educational or entertainment tool has long been known. There are different types of flashcards for children to learn in the marketplace. Most of them having pictures and alphabet letters printed on the flashcards teach one word or one alphabet on one card. The words taught in a set of flashcards usually are limited. Once children learn the word, the flashcards won't be used again. It is not economical and not environmental friendly. Moreover, children can only learn the words through vision. Their learning is not stimulated by other senses such as touching or hearing. In addition, the learning is passive, more or less a memorizing process, children are not given opportunity to actively participate.

Therefore, there exists a need for an environmental friendly and economic flashcards learning system that the flashcards may be re-used once the words or numbers or any subjects on the flashcards have been learned. It is desired that the flashcards system can have multiple function including serving as a writing board, or a clipboard, etc.

### SUMMARY OF THE INVENTION

The present invention relates to a system and method of utilizing flashcards-like clipboards, wet erase pen, die cut alphabet letters and numbers, receiver plates having female die cut holes for the die cut letters and numbers, and color coding and neodymium push pin, etc. for children to learn while playing games.

The clipboard of the present invention is generally rectangular with concave sides and rounded corners. Preferably, approximately 3 inches wide and 4.25 inches long. Other sizes may be used. It has many unique features including a surface for writing and learning, an integral clip for clipping additional notes or sheets of paper, an ID holder for holding identification card. It can also be used for tabbing projection above a sheet of paper and as an aid to help electronic book reading for children and adults with reading challenges. The clipboard is also designed to be accompanied by additional clipboards held together by a book ring that can be worn with a lanyard or put in a pocket as typical flashcards.

The clipboard-flashcards system allow for children to handle the cards and place them on the wall. Moreover, in a fun environment, children can place the die cut letters and numbers into the female die cut hole. The use of the apparatus itself allows children to trace the letters and numbers in order to obtain the “feel” of how they are to be written. Using a special wet-erase pen, children can then practice writing the letters while “magically” being able to wash away what they wrote with a damp towel. The color coding and neodymium push pin allows children to place the “push-pin” on the correct letter apparatus which is sitting on a receiver plate positioned on a wall. The system is intended to be interactive and fun. Moreover, the clipboard-flashcard system allows multiple and creative way to learn utilizing a broad range of senses collectively which includes: (A) Touch, (B) Visual and (C) Hearing.

One embodiment of the flashcards system according to the present invention includes a plurality of wall magnetic receiver plates having female die cut holes for letters and numbers and shapes, 13 paired alphabet combinations (last card being YZ) flashcards and 5 paired number combinations (last card being 8 and 9) flashcards and one card for shapes like square, circle and triangle, 26 die cut (male) alphabet letters and 10 numbers and several shapes. With the magnetic receiver plates on the wall, the child will have the “male” letters, numbers and shapes in front of her or him. For example, the child would see the “G & H” card on the wall and the “Green Face” would invoke the color green, thereby, the child would take a green wet-erase marker and color the front side of the “G & H” letters. The child after coloring-in would walk to the card on the wall and place the male letter into the female hole within the wall receiver plate. The system of learning makes these flashcards a game and the strategy of “Play” reinforces our cognitive delivery strategy. The neodymium magnet push pin is used for example with the flashcards on the wall and the teacher asked the student to walk up to the apparatuses on the wall and identify the one that has the combination of G & H.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of a flashcard clipboard according to one embodiment of the present invention.

FIG. 2 is a rear view of a flashcard clipboard according to one embodiment of the present invention.

FIG. 3 is a front view of a flashcard clipboard of the present invention with a number of die cut alphabet letters placed on the wet-erase writing surface on the clipboard.

FIG. 4 shows a magnetic receiver plate having female die cut holes for receiving male die cut alphabet letters and male die cut alphabet letters that are included in the flashcards game system according to one embodiment of the present invention.

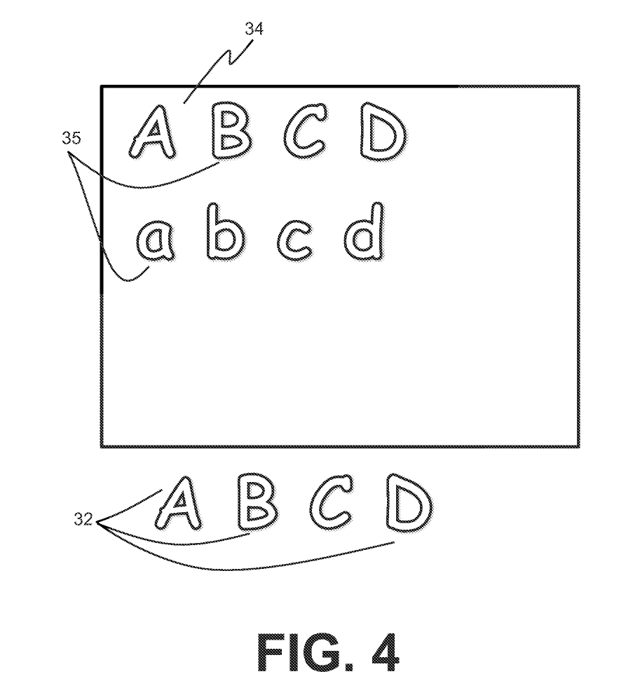

FIG. 5 discloses a front view of a clipboard working as an ebook reader aids to help children and adults having reading challenges, the clipboard has a window-cut in the middle of the clipboard.

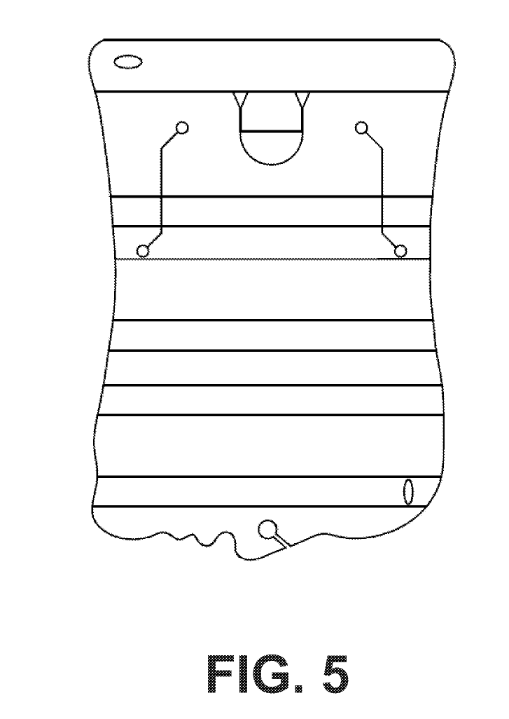

### DESCRIPTION OF THE PREFERRED EMBODIMENT

The flashcard game system 1 according to the present invention comprises at least one clipboard/flashcard, a writing instrument, a ring with lanyard, an elastic band with knob, a plurality of die cut alphabet letters or numbers or shapes, color coding and neodymium push pin and at least one magnetic receiver plate having female die cut holes for receiving the die cuts.

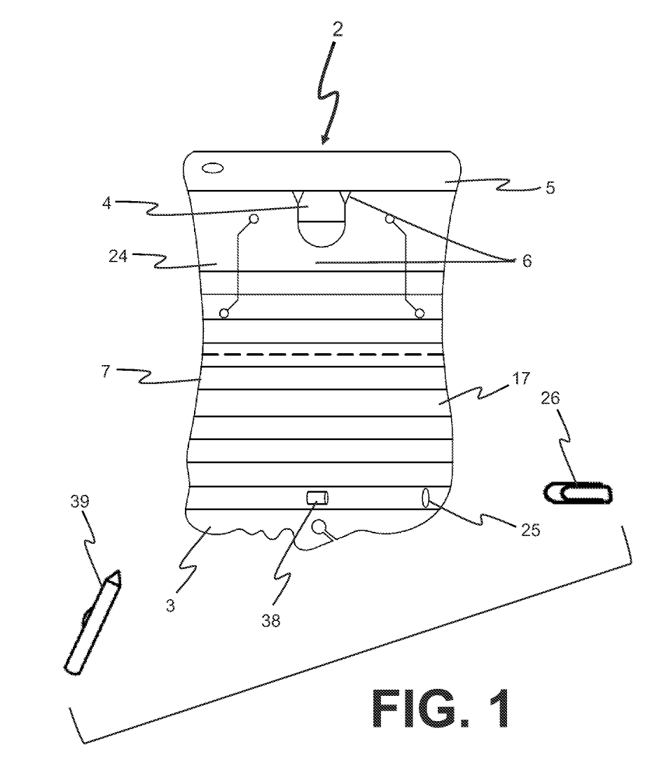

Referring to FIG. 1, there is disclosed a front view of a flashcard clipboard 2 which is generally rectangular in shape with rounded corners and is preferably approximately 3 inches wide and 4.25 inches long. Of course, other sizes may be available as long as the sizes are deemed suitable. It has two concave side edges 7 which are ergonomic for easy gripping, a flat top edge 5, and a bottom edge 3 of structural meta-cognition design for systematic focus.

The flashcard clipboard 2 may be made from plastic, aluminum, and/or cardboard stock. Part of the clipboard/flashcard 2 is a wet-erase writing surface 17 which may be made of a thermoplastic polymer that is translucent and opaque. The board may be made of a polypropylene homopolymer and a polymerized ethylene monomer is added to decrease the polymer crystallinity that increases the transparency of said surface.

The clipboard/flashcard 2 has a clip 4 integrally formed on the upper portion of the clipboard 2. The clip 4 is configured to retain at least one planar element. It is formed by a tongue disposed in a cut shape opening. Said clip 4 is positioned approximately 0.250 inches from top of the clipboard 2 wherein provides a “Tabbing” function and/or “Bookmark” when clipboard 2 is adjoined to sheet of paper. Said clip 4 as a tab formed therein capable of flexing out of said plane of said surface to secure said note card to another surface that is adjoined. The die cut hole 6 allows for a flush level plane of the clip 4 when positioned on a sheet of paper.

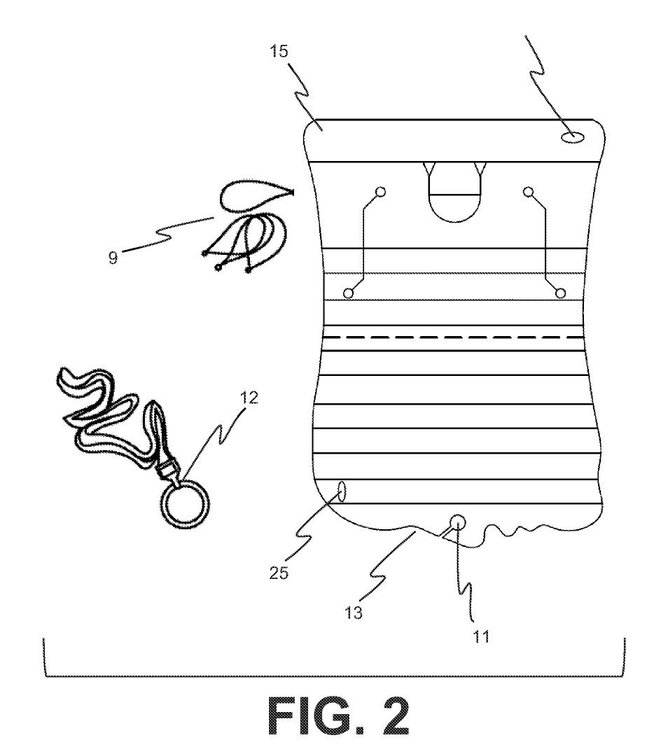

Referring to FIG. 2, there is disclosed a rear view of the clipboard 2 having an opening 8 near the top edge 5 for receiving an elastic band having a knob 9. This elastic band 9 can then hang the clipboard 2 on a push-pin affixed on a wall.

The bottom edge 3 of the clipboard has a structural meta-cognition design for systematic focus. The bottom edge 3 may have an opening 11 formed therein and channel 13 formed in said surface from the opening 11 to the bottom edge 3 of the clipboard 2. The channel 13 is capable of opening and closing by flexing the surface on either side of the channel 13 to permit a ring 12 to pass through the channel. Then, the ring 12 securing a plurality of clipboards 2 together with a short cord (lanyard) is typically worn around a child's neck.

The bottom edge 3 of the clipboard 2 is shaped with a design and is colored specifically to denote a central subject matter, sequencing steps, date, pair of alphabet letters, pair of numbers etc. thereby distinguishing it from the other 17 colors in a packaged group of 18. In one embodiment, the flashcards game system 1 according to the present invention comprises 13 alphabet letter pairs clipboards 2 and five number pairs clipboards 2. The system may further comprise other clipboards 2. The clipboard 2 invokes a meta-cognition delivery strategy around a system that focuses on a number of things arranged in a particular connected way, actions carried out that happens one after another comprising a definite order or desired sequence. Spatial form is intended for a particular purpose. This imitable shape draws attention to uniqueness and individual perspectives associated with human factors. For example, a “green” face associated with flash card containing letters “G & H” in the alphabet for letters paired in 13 groups for young students they would automatically associate this color with the fourth card in a sequence of thirteen paired alphabet letters. The red clipboard-tab might be associated with “approach” (as opposed to departure) instructions. The colors noted below are paired and sequenced for delivery strategy. For example, brown through black represent numbers 1-10. Colors to be utilize follow Cyan-Magenta-Yellow-Black sequence of light to dark that includes: Tiel, Light Blue, Navy, Light Green, Dark Green, Orange, Pink, Red, Maroon, Lavender, Yellow, Gold, Tan, Brown, Purple, Silver, Grey and Black.

On the back surface of the clipboard tabbing section, approximate ¼″ from top edge, clipboard 2 has an approximate ¼″ velcro strip 15 for adhering to any type of mating surface. Alternatively, the clipboard 2 may have a magnetic strip for adhering and/or mating with metal-aluminum type surface.

Referring back to FIG. 1, a card holder 24 is designed to hold planar paper or plastic identity card that may contain a microprocessor strip. Said card may be approximately 2.0-2.25 inches long and 3.0-3.5 inches wide and usually stiff. A round punch hole followed by 45 degree cuts forming said corners which defines the ID card inlet. Subsequently, 2 slots are used for sliding ID card into two 45 degree stop cuts which are positioned just on the inside of the first set of 45 degree cuts.

The clipboard 2 having a slot 25 in said lower portion for attaching an accessory like a paperclip 26. The functionality increases utility for attaching special notes that need to be organized with a particular card.

The clipboard 2 may further have a plurality of note sheets removably adhered to the clipboard 2 on either front surface or back surface.

In one embodiment, the clipboard 2 has a pen holder 38 secured to the bottom edge for removably receiving pen. The writing instrument, a wet erase pen 39, has a cap with a clip which snuggly fits into the pen holder 38. When a lanyard with the clipboard 2 is worn, the clipboard 2 sits in front of a child's chest in an “up-side-down” position. However, the wet-erase marker pen 39 is designed to remain “up-right” and with easy access. As the clipboard 2 is grabbed, the child naturally lifts the clipboard 2 from backside and rotates 90 degrees “up” for pen application to the board 2 surface.

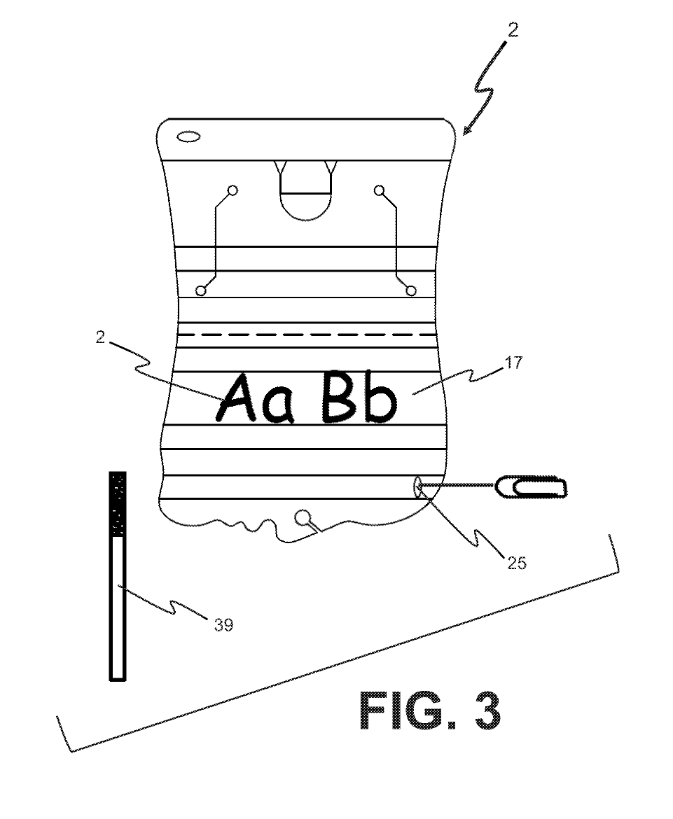

In one embodiment, the flashcards game system 1 has a plurality of die cut letters (upper & lower case) and numbers 32 so that children can trace alphabet letters or numbers 32 on the wet-erase writing surface 17 of the clipboard 2 in order to feel how they are written and form familiarity and recognition. As shown in FIG. 3, using a special wet-erase pen 39, children can then trace practice writing the letters on the surface of clipboard 2 while “magically” being able to wash away what they wrote with a damp towel. This encompasses design for knowledge acquisition for children who learn by touch (rather than sound or reading). In this scenario, a package would include 13 Flash Cards—Clipboards (A-Z) as well as 5 clipboards designated for numbers (0-9).

The flashcards game system 1 also has at least one magnetic receiver plate 34 having female die cut holes 35 for receiving die cut letters or numbers 32. Children can place the die cuts 32 of letters or numbers into the female die cut holes 35. The color coding and neodymium push pin allows children to place the “push-pin” on the correct female die cut hole 35 which is sitting on a magnetic receiver plate 34 positioned on a wall.

These die cuts letters and numbers 32 as well as wall receiver plates 34 may have neodymium magnet on their backs so that they can be affixed to any metal surfaces such as refrigerator door.

Alternatively, the flashcard clipboards 2 can be carried in pockets. Designed to “fit” most all shirt and suit pockets, the clipboard 2 is approximately 4.25 inches in length and 3 inches in width for transporting ease.

The flashcard clipboard 2 has a space on at least one side designated for children “stickers” with pressure sensitive adhesive. The polypropylene homopolymer allows the stickers to be easily removed from the outermost thin layer that can be touched and defined in 2 dimensions. Young students are taught to associate an object spelling with that of the “alphabet” letter reference. The sticker objects are inter-mixed with more advanced spellings (corresponding to specific associated objects) as learning progresses.

One embodiment according to the present invention has a die-cut window 31 which is located at the middle of the clipboard which extends from the location below the clip to near the bottom edge 3. A “window” 31 is for young children or adults learning to read and/or with Dyslexia. In either case, the clipboard window 31 reduces directionality confusion and energy trying to follow the words on one single line. When device is used as a bookmark for paperback manuals or text, the “window” 31 is used to denote where the student left off as finding specific words within a group of text can be challenging with said learning disabilities. Specifically built for electronic devices like the Apple iPod where the depth of the window 31 sits approximately 0.5 inches. The device is turned “horizontal” where the top 5 in the vertical position now becomes the side bar which slides up and down the side of the electronic book device. The window made to structurally accommodate (at the very least) the 3 most widely used electronic book devices models.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A flashcards system comprises at least one clipboard having a wet-erase writing surface and a wet-erase pen.

2. The flashcards system of claim 1 further comprises a plurality of die cut alphabet letters and numbers, and at least one magnetic receiver plate having female die cut holes for receiving the die cuts.

3. The flashcards system of claim 2, wherein the clipboard has two concave sides for easy gripping, a top edge, and a bottom edge with structural meta-cognition design for systematic focus, the bottom edge is colored specifically to denote a specific pair of alphabet letters or a specific pair of numbers.

4. The flashcards system of claim 3, wherein the clipboard has an opening near the top edge for receiving an elastic band with a knob secured thereto.

5. The flashcards system of claim 3, wherein the clipboard has an opening near the bottom edge and a channel formed from the opening to the bottom edge of the clipboard, the channel capable of opening and closing by flexing the surface on either side of the channel to permit a book ring to pass through, the book ring securing a plurality of clipboards together with the lanyard to be typically worn around the neck.

6. The flashcards system of claim 2, wherein the clipboard has an integral clip which is configured to retain at least one sheet of paper or at least one note card.

7. The flashcards system of claim 2, wherein the wet-erase writing surface of the clipboard is made of thermoplastic polymer.

8. The flashcards system of claim 2, wherein the wet-erase writing surface of the clipboard is made from a mixture of polypropylene homopolymer and polymerized ethylene monomer.

9. The flashcards system of claim 8, wherein the clipboard has a space designated for children “stickers” with pressure sensitive adhesive.

10. The flashcards system of claim 2, wherein the clipboard has a card holder designed to hold planar paper or plastic identity card.

11. The flashcards system of claim 2, wherein the clipboard has a pen holder near the bottom edge for receiving wet-erase pen.

12. The flashcards system of claim 2, wherein the clipboard has a die-cut window located at the middle of the clipboard which extends from the location below the clip to near the bottom edge, the “window” is for young children or adults with reading challenge.

13. The flashcards system of claim 12, wherein the depth of the die-cut window sits approximately 0.5 inches.

14. The flashcards system of claim 2, wherein the clipboard is made from plastic or cardboard stock.

15. The flashcards system of claim 2, wherein the clipboard has an approximately 0.25 inches Velcro strip on its back for adhering to any type of mating surface.

16. The flashcards system of claim 2, wherein the clipboard has an approximately 0.25 inches magnetic strip on its back for adhering to metal-aluminum type surface.

17. The flashcards system of claim 2, wherein the die cut alphabet letters and numbers and wall receiver plates have a magnet on their back surface.

18. The flashcards system of claim 2 further comprises neodymium magnet push pins and a plurality of note sheets.

19. A flashcards system comprises:
at least one clipboard having a wet-erase writing surface;
a wet-erase pen;
a plurality of die cut alphabet letters and numbers; and
at least one magnetic receiver plate having female die cut holes for receiving the die cuts; wherein the clipboard has two concave sides for easy gripping, a top edge, and a bottom edge with structural meta-cognition design for systematic focus, the bottom edge is colored specifically to denote a specific pair of alphabet letters or a specific pair of numbers; the clipboard has an integral clip for securing sheets of paper, a card holder for holding identification cards, an opening for allowing book ring to secure thereto, and a pen holder for receiving the wet-erase pen.

20. The flashcards system of claim 19, wherein the clipboard, the wet-erase pen, the die cut alphabet letters and numbers and the receiver plate have neodymium magnet on their back surface.
